(19) United States
(12) Patent Application Publication
(10) Pub. No.: US 2025/0317372 A1
(43) Pub. Date: Oct. 9, 2025

(54) TESTING DEVICE AND METHOD FOR TESTING A COMMUNICATION BETWEEN AT LEAST TWO PARTICIPANTS

(71) Applicant: dSPACE GmbH, Paderborn (DE)

(72) Inventors: Jochen SAUER, Paderborn (DE); Peter AREND DE MARINS, Paderborn (DE); Thoren GRUETTEMEIER, Paderborn (DE)

(73) Assignee: dSPACE GmbH, Paderborn (DE)

(21) Appl. No.: 19/172,420

(22) Filed: Apr. 7, 2025

(30) Foreign Application Priority Data
Apr. 8, 2024 (DE) 10 2024 109 715.9

(51) Int. Cl. H04L 43/0817; H04L 67/12

(52) U.S. Cl. CPC H04L 43/0817; H04L 67/12

(57) ABSTRACT

A testing device for testing a communication between at least two participants. The testing device is set up to evaluate the communication on the basis of at least one state transition of at least one of the participants. The evaluation includes the determination of a deviation of the evaluated communication from a default. The default contains information on states and/or state transitions of the at least one participant. The testing device also has an output device that is set up to output first data depending on the evaluation.

This nonprovisional application claims priority under 35 U.S.C. § 119(a) to German Patent Application No. 10 2024 109 715.9, which was filed in Germany on Apr. 8, 2024, and which is herein incorporated by reference.

### BACKGROUND OF THE INVENTION

### Field of the Invention

The invention relates to a testing device and a method for testing a communication between at least two participants. The application also relates to the use of the testing device for testing a communication between a vehicle that is at least partially electrically powered and a charging device to provide electrical energy for the vehicle that is at least partially electrically driven.

### Description of the Background Art

A communication can take place on the basis of one or more standards between a charging station for the provision of electrical energy and a vehicle that is at least partially electrically powered, or a correspondingly suitable control unit of the vehicle. These standards are available in several versions from the respective committees of the individual states or associations of states and are accompanied with explanatory documentation. The individual commands, but also the states and transitions of the states and boundary conditions for the communication participants are described here. Based on this information, the manufacturers of the at least partially electrically powered vehicles and the charging stations try to make communication as standard-compliant as possible in order to ensure smooth operation in the field.

### SUMMARY OF THE INVENTION

It is therefore an object of the invention to further improve a testing device and a method for testing a communication between at least two participants.

In an example, a testing device for testing a communication between at least two participants has the following characteristics: the testing device is set up to evaluate the communication on the basis of at least one state transition of at least one of the participants; the evaluation includes the determination of a deviation of the evaluated communication from a default; the default contains information on states and/or state transitions of the at least one participant; and/or the testing device also has an output device that is set up to output first data depending on the evaluation.

The testing device can be used to test communication between a vehicle that is at least partially electrically powered or its corresponding control unit and a charging device for the provision of electrical energy for the vehicle that is at least partially electrically powered. In this case, the vehicle that is at least partially electrically driven, or its corresponding control unit, can be one of the participants in the communication, and the charging device for the provision of electrical energy can be another of the participants in the communication.

A method for checking a communication between at least two participants includes: an evaluation of the communication on the basis of at least one state transition of at least one of the participants, wherein the evaluation includes the determination of a deviation of the communication from a default, wherein the default contains information on states and/or state transitions of the at least one participant; and an output of first data depending on the evaluation. The evaluation can include the recording of the assumption of states and/or the use of state transitions by at least one participant.

The testing device and the method make it possible to check the conformity of the tested communication with a standard and optionally identify optimization potential.

The testing device, for example, is a so-called Hardware in the Loop (HIL) test bench, which is used to test the function of a device to be tested as hardware. The device to be tested may be, for example, a battery control unit for the traction battery for the vehicle that is at least partially electrically driven. The device to be tested is offered various test scenarios via its interfaces. It is then monitored to what extent and how the device to be tested reacts to the signals offered. This can then significantly reduce or even avoid time-consuming test drives. It is also possible that the testing device enables a so-called Software in the Loop (SIL), i.e., in which the device to be tested is bodiless and is only available as software.

The testing device tests the communication between the at least two participants, for example the vehicle that is at least partially electrically powered and the charging device that provides electrical energy for charging a battery of the partially electrically powered vehicle. A communication between two such participants concerns technical requirements and offers, but also commercial data, which is exchanged, for example, in order to correctly record and/or pay for the electrical energy consumed. A communication can usually be carried out wired via connected wires or cables from the vehicle to the charging facility; but it can also be an optical line or a wireless connection between the two participants. As stated above, a communication is defined by a default, such as a standard or a communication model, e.g., a UML diagram for protocol default. Communication technology has many forms of communications with such standards in order to achieve simple interoperability.

A communication is an exchange of data via a digital transmission. A communication can also be carried out via analog transmission. Wired and/or non-wired technologies can be used for a communication.

Information about communication standards can be stored in the testing device as a default. The testing device can compare the actual communication with the default. For this purpose, the testing device is set up to evaluate the communication on the basis of the at least one state transition of at least one of the participants. Therefore, the testing device evaluates state transitions and states that at least one of the participants assumes or runs through during the communication. The evaluation can be carried out, for example, by means of an algorithm that is part of the software of the testing device. This means that such an evaluation of the communication of the participants can be carried out automatically in a simple way.

The evaluation now determines a deviation of the evaluated communication from the default, for example the standard. Ideally, the deviation can be zero. This comparison is carried out by an algorithm, i.e., a calculation rule that is implemented in software. Therefore, the default contains information on states and state transitions that the at least one participant should assume or run through. It may also be required that it be clear a priori which state or state transition the participant goes through when working according to the standard.

The testing device also has an output device that is set up to output first data depending on the evaluation. The output can be made via an electronic, optical or radio interface, but also a representation, for example, on a display, e.g., a monitor, is possible.

The testing device can analyze the communication between the participants while the communication itself is taking place. Optionally, the analysis can also take place later in an offline mode based on recorded communication data.

It is possible to derive a communication model based on the communication. A communication model describes the communication between the participants in the communication. Such models can have UML models (UML: Unified Modeling Language), textual and/or graphical models or representations using graphs. The description of a protocol of a communication can also be called a communication model. This can be represented using a state machine, for example. The state machine comprises the states of the participants, the information exchanged and the state transitions of the participants. It can also be referred to as a change of state diagram. Another communication model, i.e., a default model, can also be derived on the basis of the default. For example, by comparing the communication models, the evaluation can be carried out by the testing device.

A finite automaton or also finite state machine or finite state automaton is a model of a behavior formed of states, state transitions and actions. A state machine is called finite if the number of states it can assume is finite. A finite state machine is a special case from the number of machines.

A state that a particular participant has reached can optionally contain information about the participant's past. The information about the past can include, for example, information about states assumed in the past and/or about events processed in the past.

A state transition is a transition from the current state to a new, different state. This transition occurs when the specified logical conditions and inputs are present that must be met to make the transition possible. For the state machine, a state transition diagram can be used to visualize the state transitions and the states themselves.

The testing device can be used to test the communication between the vehicle that is at least partially electrically powered and the charging device for the provision of electrical energy for the vehicle that is at least partially electrically driven. This use case, which falls under the so-called Car-to-X communication, relates to various use cases of communication. For one, the vehicle must log on to the charging facility via a communication, for example in combination with a chip card or a code. Secondly, the charging of electrical energy into the vehicle's battery also requires an exchange of the communication regarding the possible charging speed and, for example, also regarding tariff options. A payment process can also be handled via such a communication.

The evaluation can include the recording of the assumption of states and/or the use of state transitions by the at least one participant. This allows for the above-mentioned state machine to be analyzed. It can also be used to identify, suggest and, if necessary, make the appropriate optimizations. The recording is carried out with an algorithm, for example. For example, the algorithm is able to query these states and state transitions from the respective participant. The communication content is also included in this recording.

The output first data can include a graphical representation of the states and/or state transitions assumed by the at least one participant. Suggestions for optimizing communication and/or optimizing a process accompanying the communication can also be output in this way. The graphical representation may be, for example, a state transition diagram. This visualizes the sequence of states and state transitions for the participants, so that optimizations and analyses by a user are then possible in a simple way.

The first data output can also include a graphical representation of the deviation of the evaluated communication from the default. Here, therefore, the differences between the default, for example the communication standard mentioned, and the actual communication are presented. This can also be done in the form of a state machine, which can be marked accordingly, for example.

The output of the first data can have a graphical representation of a state machine. This then enables the entire analysis of the communication sequence.

The evaluation can include recording a duration during which a respective state is assumed. This temporal analysis can also be used to optimize and draw conclusions about the communication.

Furthermore, the evaluation may include a quantitative evaluation, in particular a statistical evaluation of the assumption of states and/or the use of state transitions by the at least one participant. This can be used to show frequent events such as the assumption of certain states or the use of state transitions, which can provide indications of a load on the system. Optimizations can then be derived from this and output as optimization notes.

It is thus possible to optimize the communication between the participants themselves, for example by processing frequently occurring states or state transitions via more powerful memory sections. This can then speed up the communication.

The testing device can have a memory in which the default is stored. This means that information about the communication standards used is stored in the memory, for example. This enables the testing device to retrieve them for comparison.

The default may contain information, in particular a diagram and/or textual instructions, on at least one protocol and/or at least one communication standard. Based on this information, it is then possible to compare the current communication between the participants with the default.

Furthermore, it is possible that the testing device can be set up to receive second data, with the second data comprising the at least one state transition. With this second data, the evaluation of the communication can then be further improved and/or facilitated. The second data can be received during the communication, as can the evaluation by the algorithm. The algorithm for evaluation preferably runs on the test system and thus does not impair the communication of the two participants.

The second data can be received before the evaluation of the communication, wherein a model of the communication is created from the second data, which is compared with the default model. The testing device can therefore be set up to create the model of the communication from the second data, which can be compared with the default model.

For example, the testing device can be set up to derive the communication model on the basis of the second data.

For example, the default can be generated using artificial intelligence, wherein the artificial intelligence uses stored second data to generate the default.

In addition, it is possible that the testing device is set up to receive the second data from the at least one participant and/or from an offline memory. This means that this second data can be sent by a participant without longer intermediate storage, or this second data is temporarily stored in the offline memory and can then be loaded for evaluation later well after the end of the communication to which the second data belongs.

Furthermore, it is possible that the second data can have at least one event associated with the state transition and/or a state of the at least one participant and/or information of a technical requirement of the communication. This additional information about the communication enables an improved evaluation of the communication itself.

The testing device can be designed as an additional participant in the communication. In this case, the testing device can be the additional participant in addition to the at least two participants.

It is also possible that another participant in the communication, e.g., by equipping the software with the test algorithm, acts as a testing device, in particular without impairing the communication between the participants.

The testing device may be set up to receive the communication between the at least two participants and to send it to the other participant who is to receive the sent communication. The testing device is then a kind of relay station for the communication.

The testing device may be designed as one of the at least two participants in the communication. Here, the testing device can also function as a charging station, for example, if the other participant is the vehicle that is at least partially electrically driven. Conversely, the testing device can also act as the vehicle, for example, if the other participant is the charging station. It is also conceivable that the testing device is integrated into the charging station and/or the vehicle.

This allows for various configurations through which the testing device can be integrated into the communication. Either as a separate participant or as a kind of relay station or as one of the at least two participants in the communication.

In particular, it is possible for the testing device to operate as a charging facility to provide electrical energy for a vehicle that is at least partially electrically powered. This means that the vehicle-side loading device can be tested by the testing device. Alternatively, it is also possible for the testing device to take on the role of the vehicle-side communication and then test the other participant as the stationary charging device with regard to the communication.

At least one participant of the at least two participants can have a control unit for charging management for the vehicle or simulates a control unit for charging management for the vehicle, at least in part. Such a control unit is part of the above-mentioned charging device, both on the vehicle side and on the infrastructure side, i.e., the stationary charging device. This can then be used to test such a control unit for charging management via the testing device. During the charging process, this control unit ensures that the charging process runs as optimally as possible, for example with regard to the charging speed and the heating of the energy storage system on the vehicle side during charging. There are other parameters that this control unit can take into consideration. The control unit on the infrastructure side, for example, can manage the available energy and communicate with the vehicle's control unit about the charging speed that is currently possible. Commercial processing of charging can also be handled or at least enabled via the control unit.

It is proposed that the default be generated using artificial intelligence, with the artificial intelligence using stored second data to generate the default. This means that artificial intelligence, usually embodied by a neural network, is trained to shape the default via the second data and the information about the communication standards. For example, the default can be generated from a description of the standard using artificial intelligence.

In addition, it is proposed that, depending on the evaluation of the communication, a communication model for the communication is created, wherein a default model is used as the default and the evaluation includes a comparison between the communication model and the default model. The modeling is carried out, for example, via the state flow diagrams mentioned above, which show the respective state and the state transitions graphically.

Furthermore, a method for testing (by means of the aforementioned testing device) the communication between at least two participants is proposed, comprising: an evaluation of the communication on the basis of at least one state transition of at least one of the participants, wherein the evaluation includes the determination of a deviation of the communication from a default, wherein the default contains information on states and/or state transitions of the at least one participant, and output of first data depending on the evaluation.

The method can preferably be carried out with the testing device described above.

The evaluation is quantitative, especially statistical.

In an example of the method, the first data is output graphically using a state machine.

Before the communication is evaluated, second data is received, with the second data comprising at least one state transition.

The default can be generated using artificial intelligence, wherein the artificial intelligence uses stored second data to generate the default.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of the communication between two participants and a listening testing device;

FIG. 2 shows a further schematic representation of the communication between two participants and the testing device as the third participant;

FIG. 3 shows a further schematic representation of the communication between the two participants and the testing device as a relay station for the communication;

FIG. 4 shows a schematic representation of an offline evaluation of the communication by the testing device;

FIG. 5 shows a flowchart of the method;

FIG. 6 shows a communication model as a state machine from the point of view of a participant;

FIG. 7 shows a table with a record of a communication sequence;

FIG. 8 shows a state machine of the communication sequence of FIG. 7 from the point of view of a participant;

FIG. 9 shows a table with a record of a further communication sequence;

FIG. 10 shows another state machine with the merged communication sequence of FIGS. 7 and 9;

FIG. 11 shows the state machine of FIG. 10 in a minimized form;

FIG. 12 shows the state machine of FIG. 10 in a further minimized form;

FIG. 13 shows a table with a record of a further communication sequence;

FIG. 14 shows the state machine of FIG. 1 with initialized counters; and

FIG. 15 shows the state machine of FIG. 4 with a counter reading to verify a communication.

### DETAILED DESCRIPTION

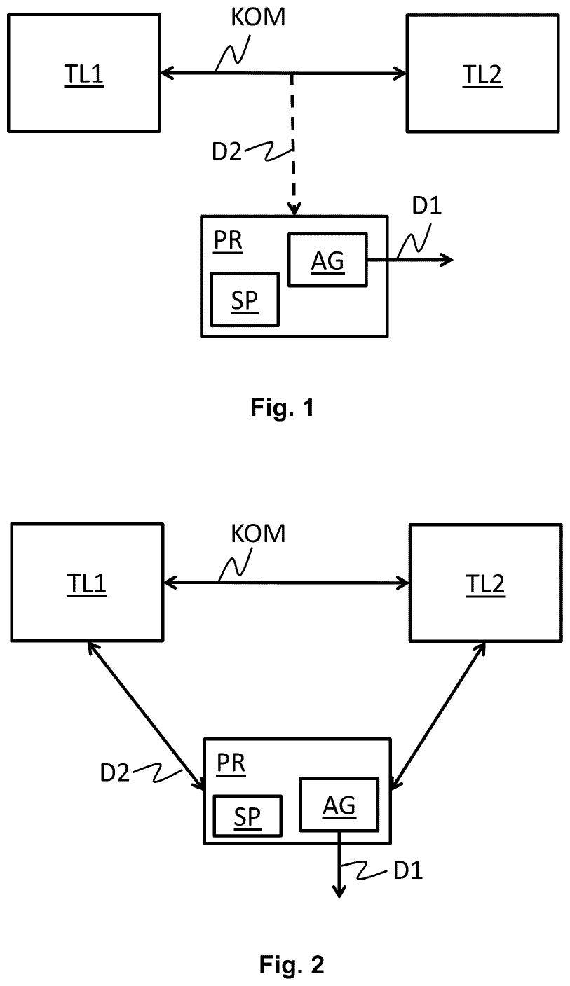

FIG. 1 shows the communication KOM between two participants TL1 and TL2, wherein the communication KOM is listened to by a testing device PR, wherein the data D2 for this purpose is taken or derived from the communication KOM. The data D2 is transferred to an electronic memory SP and evaluated by the testing device PR.

The evaluation includes the determination of a deviation of the data D2 from a default, which is, for example, a communication standard according to which the communication KOM is to take place. In particular, it is possible for the testing device PR to create a communication model based on the data D2 and compare it with a corresponding model from the data of the default. Data D1 is generated from this model comparison, which is output via the output device AG. The data D1 may contain the extent to which the communication KOM meets the standard. This can include a statement as to whether the communication KOM meets the requirements of the standard. If not, it is also possible to output how often the standard has been violated and which standard default has been violated and how often.

The data D1 can also provide hints on how to optimize the communication KOM. Such hints include, for example, that frequent states and/or frequent state transitions can take place in more powerful memory areas in the future in order to speed up the communication KOM.

It is also possible for the data D1 to contain statistical evaluations of the communication KOM, for example how often a certain state transition was run through or how long a state was assumed.

The testing device PR therefore has, e.g., a processor that is able to perform the evaluation.

FIG. 2 shows an alternative configuration of the two participants TL1 and TL2 as well as the testing device PR for the communication KOM. According to this configuration, the testing device PR is a third participant in the communication KOM. The testing device PR therefore receives the data D2, for example, from the first participant TL1, which simulates or represents a vehicle-side part of a charging device, for example. This communication KOM from the point of view of the participant TL1 is to be optimized and analyzed, for example. The rest of the functionality of the testing device PR is as described in FIG. 1. The second participant TL2 can, for example, simulate or represent the stationary part of a charging device, e.g., a charging station.

Instead of evaluating the communication KOM from the point of view of the first participant, an evaluation of the communication KOM from the point of view of the second participant TL2 is also possible. Then, the testing device PR would receive the second data D2 from the first participant. The evaluation of the communication KOM from the point of view of the second participant TL2 is also possible in addition to the evaluation of the communication KOM from the point of view of the first participant TL1.

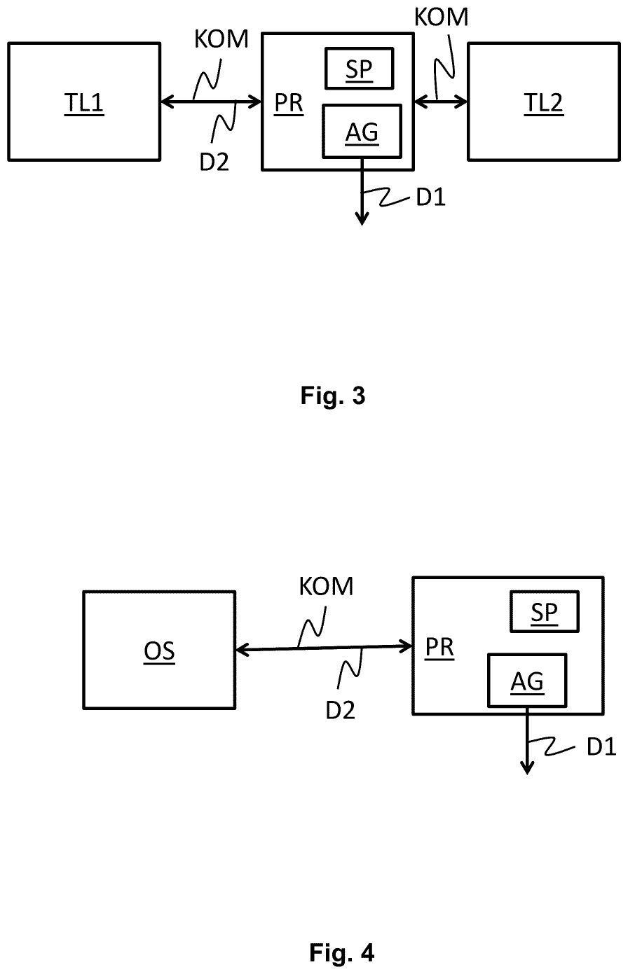

FIG. 3 shows another alternative of how the two participants T1 and T2 as well as the testing device PR can be combined to evaluate the communication KOM. Now, the testing device PR is connected between the two participants TL1 and TL2, so that the communication KOM is sent via the testing device PR to the respective other participant, i.e., the one who did not send. This means that the testing device works like a relay station for the communication KOM. This can also be referred to as “man-in-the-middle”.

The testing device PR receives the data D2 from the first participant TL1 for evaluation. Alternatively, the data D2 can also be provided by the participant TL2 or even by both participants TL1 and TL2. Again, the same components with corresponding functions correspond to those already described in FIG. 1 and FIG. 2, so that the output device AG in turn outputs the data D1.

FIG. 4 shows in a schematic representation how the testing device PR receives the data about the communication KOM, including the data D2 from an offline memory OS. It is also optionally possible for the testing device PR to retrieve only the data D2 from the offline memory OS.

This means that the communication KOM between the participants TL1 and TL2 has already taken place, but it has been stored in the offline memory OS, so that the testing device PR can evaluate the communication KOM later. This is done in turn using the data D2. And again, the working method corresponds to the testing device PR, as it has already been described for FIGS. 1-3. The testing device PR also has the same functional components as described for FIGS. 1-3.

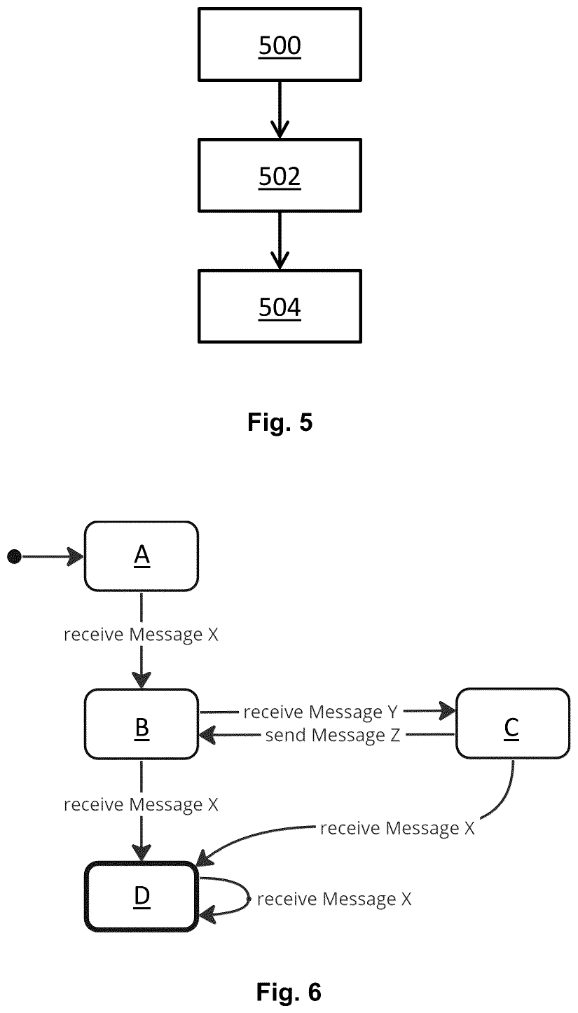

FIG. 5 shows a flowchart of the method according to this application. In step 500, the testing device PR receives the data D2 for evaluation, e.g., from the participant TL1.

This evaluation is carried out in step 502, so that in step 504 the output of data D1 is carried out by the output device AG depending on this evaluation of the data D2. The data D1 contains the extent to which the default was complied with in the communication KOM. The data D1 may continue to contain statistical data on the communication KOM, but it may also contain suggestions for optimizing the communication KOM.

FIG. 6 shows in a state machine diagram how a communication KOM can proceed from the point of view of the participant TL1. First, participant TL1 assumes state A. Participant TL1 receives the message X and then switches to state B. Participant TL1 then receives message Y and then switches to state C. After that, participant TL1 sends message Z and returns to state B. However, if participant TL1 receives message X from state C, participant TL1 enters the final state D. Participant TL1 also runs from state B to final state D when message X has been received. Participant TL1 remains in final state D even if participant TL1 receives message X while participant TL1 is already in state D.

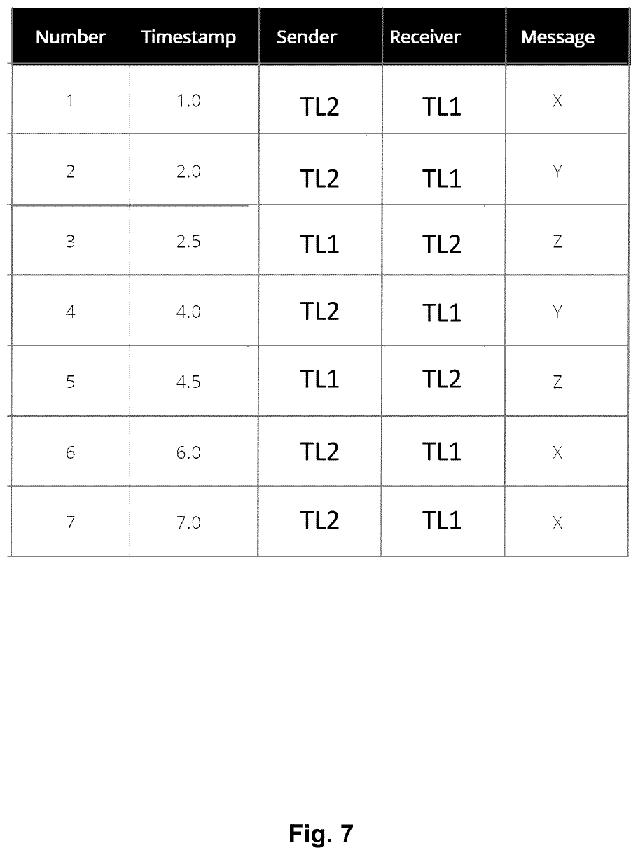

FIG. 7 shows a table that represents a record of a communication sequence. In the first column, the steps in the communication that correspond to states are counted off. In the present case, seven steps are listed.

The second column, titled Timestamp, lists a timestamp for each step. The different distances between the timestamps in the adjacent lines make it clear that some of the steps are of different lengths.

The third column indicates who sent the message (sender), either participant TL1 or TL2, and correspondingly the fourth column (receiver) indicates who received it.

In the fifth column, the message that has been sent is described, wherein in this case it can be messages X, Y or Z.

A state machine can be derived from this table and used to create a communication model.

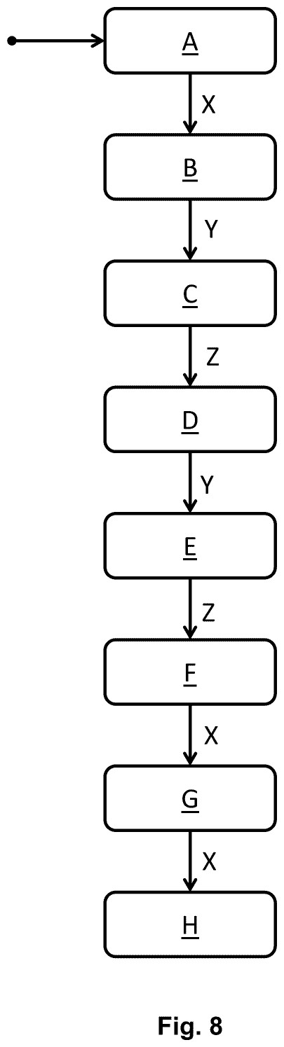

FIG. 8 shows the state machine for the communication of FIG. 7. Starting from state A from the point of view of the participant TL1, message X is sent from TL2 to TL1. Participant TL2 is therefore the sender and participant TL1 is the receiver.

As a result of receiving message X, participant TL1 enters state B. Then participant TL2 sends message Y to participant TL1, so that this participant TL1 is transferred to state C. Participant TL1 then sends message Z to participant TL2. This causes participant TL1 to enter state D.

Then, participant TL2 sends message Y to participant TL1 and participant TL1 consequently enters state E. Participant TL1 then sends message Z the participant TL2. This causes participant TL1 to enter state F. Then, participant TL1 receives message X from TL2 and enters state G and receives this message X from TL2 again, so that participant TL1 enters the final state H. This then creates the model of the communication. With each message, a new state is reached.

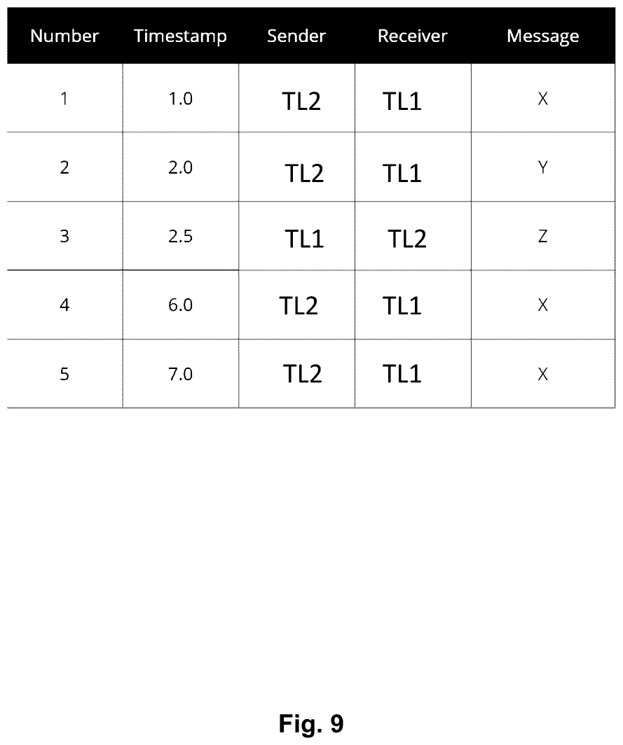

FIG. 9 shows a table that represents a record of a further communication sequence. In the first column, the steps in the communication that correspond to states are counted off. In the present case, five steps of the further communication are listed.

The second column, titled Timestamp, lists a timestamp for each step. The different distances between the timestamps in the adjacent lines make it clear that some steps are of different lengths.

The third column indicates who sent the message (sender), either participant TL1 or TL2, and correspondingly the fourth column (receiver) indicates who received it.

In the fifth column, the message that has been sent is described, wherein in this case it can be messages X, Y or Z.

From this table, a state machine can be derived and used to create a communication model.

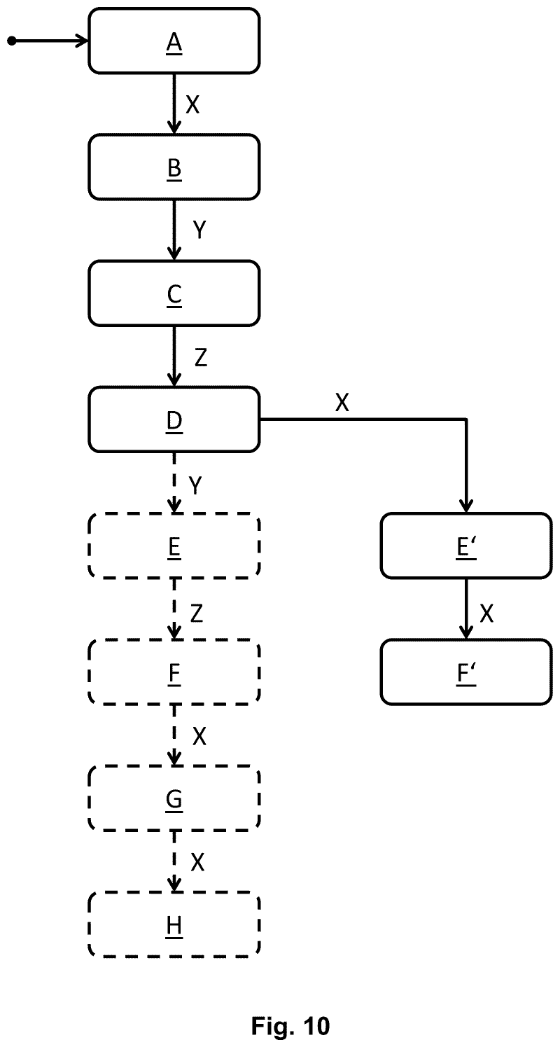

FIG. 10 shows the state diagram of FIG. 8, which has been supplemented by states for the further communication from FIG. 9. On the right side, the state machine has been extended by states E′ and F′, which belong to the communication of FIG. 9. Otherwise, the state diagram on the left corresponds to the description of FIG. 8.

From state D of participant TL1, a new transition to a new state E′ is made by receiving message X from participant TL2. From this state E′, participant TL1 then enters state F′ through a new reception of message X from participant TL2. State F′, just like state H, is a final state.

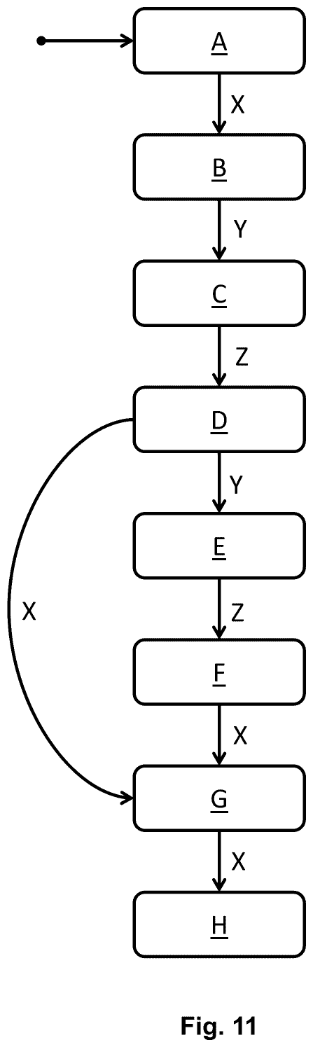

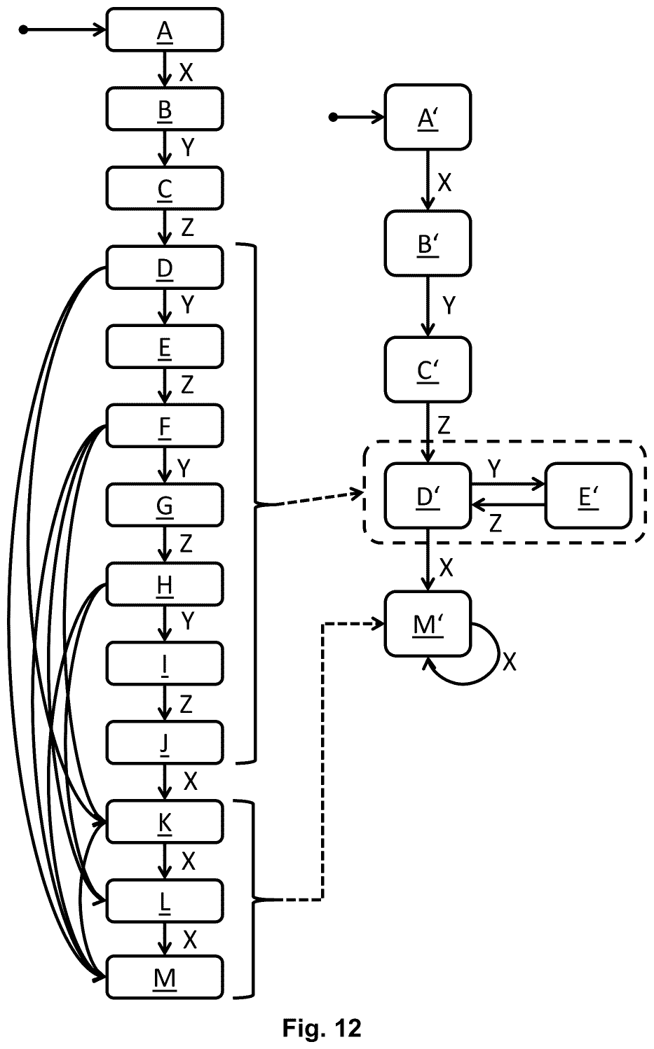

FIG. 11 shows another state diagram. It shows the same communication shown in FIG. 10, but in FIG. 11 the so-called Hopcroft algorithm was applied to minimize the state model and thus the state diagram. The branch from FIG. 10 is merged with states G and H, i.e., state E′ is merged with state G and state F′ is merged with state H. This minimizes the state model by merging states that are functionally identical. Since both state H and state F′ are final states, they can be merged and correspondingly also states E′ and G, which are respectively the state before the final state.

FIG. 12 shows another, more complex state model in the left part, which was created by processing further recordings of the communication sequences according to the work steps shown in FIGS. 9, 10 and 11. In this state model, it is noticeable that the messages or transitions Z and Y between states D to J point to a loop. Therefore, a reduction from D to J to the states D′ and E′ is possible. This is shown in the right part of FIG. 12 and is outlined with dashes. The final states K, L and M can be merged into the state M′ because the reception of message X is repeated.

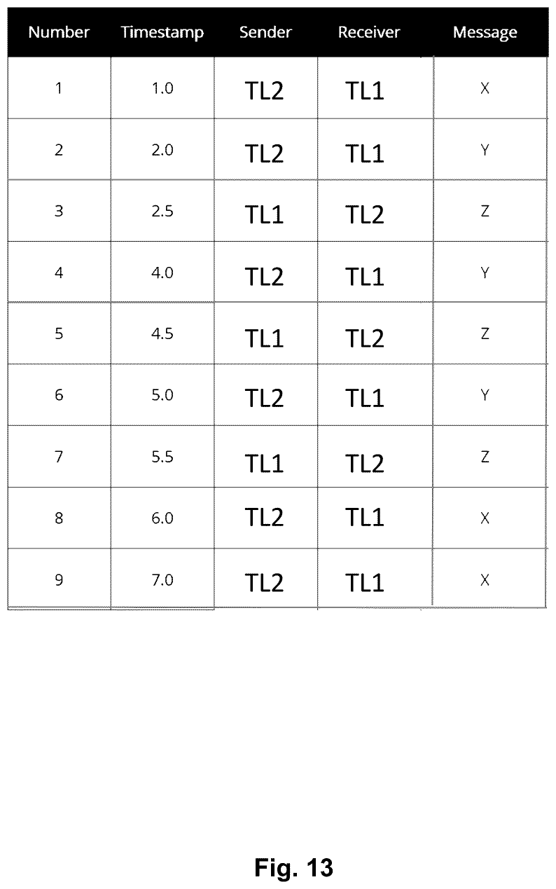

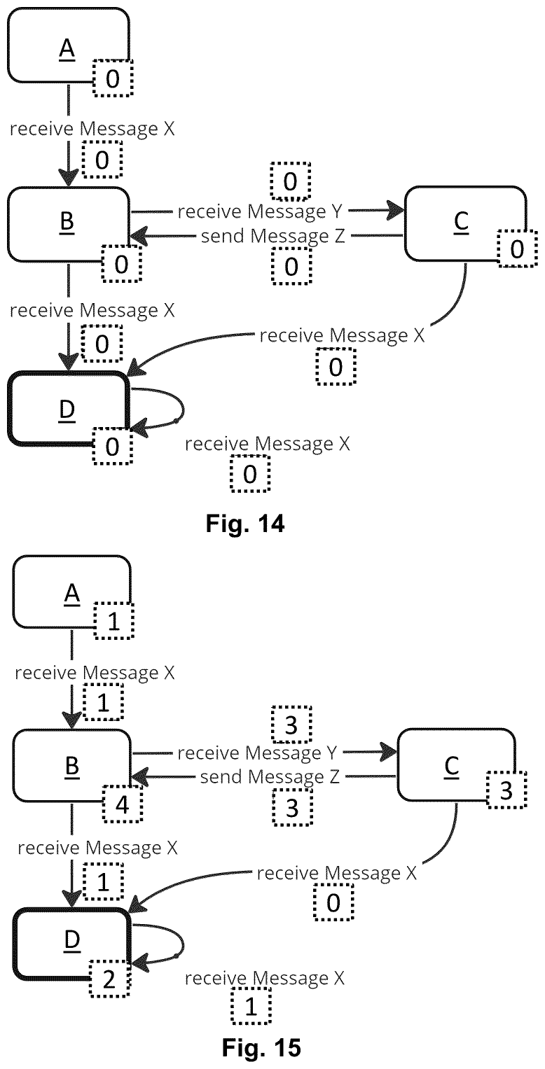

FIG. 13 shows a table of the communication of FIG. 6. The communication is graphically represented in the following FIGS. 14 and 15 by a respective state diagram. The format of the table is as described above. There are nine entries. Again, messages X, Y and Z are sent or received.

FIG. 14 shows a state model from the point of view of participant TL1 with states A to D, wherein D is the final state. From state A, participant TL1 enters state B by receiving message X sent by participant TL2. From state B, the state machine enters the final state D through the re-reception of message X. Starting from state B, however, the state machine enters state C when the participant TL1 receives message Y. From state C, the participant TL1 returns to state B when participant TL1 sends message Z. From state C, participant TL1 also enters final state D if the first participant TL1 receives message X from the other participant TL2. Each state is assigned a counter that indicates how many times the state has been run through.

FIG. 14 shows the state model in its initialized state. Each state in the model is marked with a counter reading of zero, wherein when the respective state is reached, the respective counter is increased by one. The table in FIG. 13 describes who sends or receives which messages. The result, namely the state machine of FIG. 14 after running through the communication of FIG. 13, can be seen in FIG. 15. The counter reading in state A is one, because participant TL1 has changed from state A to B once after receiving message X. State B has been reached 4 times, once starting from state A and three times starting from state C, and this is because the message Z has been sent three times. The state C was also reached three times, because three times message Y was received from state B. Message X was received zero times from state C. Message X was received once from state B. Therefore, state D was reached once on the basis of this and a second time by a renewed reception of message X.

This means that no faulty transitions were detected. The final state was reached, and a transition was not tested, namely between C and D. The transitions between B and C were statistically used more frequently. The requirement is that the more frequently executed actions between states B and C could be optimized. For example, the associated code parts (instructions) or data variables can be moved to more powerful memory areas. Furthermore, a test case should be added that uses the transition between state C and final state D. If an invalid or unspecified transition had been discovered, the following could happen: in order to establish interoperability, this transition could be adopted into the implementation or standard.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A testing device to test a communication between at least two participants, the testing device comprising:
an output,
wherein the testing device is set up to evaluate the communication on the basis of at least one state transition of at least one of the participants,
wherein the evaluation includes the determination of a deviation of the evaluated communication from a default,
wherein the default contains information on states and/or state transitions of the at least one participant,
wherein the evaluation includes a recording of the assumption of states and/or the use of state transitions by the at least one participant, and
wherein the output of the testing device is configured to output first data depending on the evaluation.

2. The testing device according to claim 1, wherein the output first data comprise a graphical representation of the states assumed by the at least one participant and/or the state transitions, and wherein the output first data comprises a graphical representation of the deviation of the evaluated communication from the default.

3. The testing device according to claim 1, wherein the output of the first data has a graphical representation of a state machine.

4. The testing device according to claim 1, wherein the evaluation comprises a recording of a duration during which a given state is assumed.

5. The testing device according to claim 1, wherein the evaluation comprises a quantitative evaluation, or a statistical evaluation, of the assumption of states and/or the use of state transitions by the at least one participant.

6. The testing device according to claim 1, wherein the testing device receives second data, and wherein the second data comprise at least one state transition.

7. The testing device according to claim 1, wherein the default contains information on at least one protocol and/or at least one communication standard, and/or a diagram and/or textual instructions as a default model.

8. The testing device according to claim 7, wherein the testing device is set up to derive a communication model from the second data for comparison with the default model.

9. The testing device according to claim 6, wherein the second data have at least one event assigned to at least one state transition and/or a state of the at least one participant and/or information on a technical requirement of the communication.

10. The testing device according to claim 1, wherein the testing device is designed as a further participant in the communication.

11. The testing device according to claim 1, wherein the testing device receives and sends the communication between the at least two participants.

12. The testing device according to claim 1, wherein the testing device is one of the at least two participants in the communication.

13. The testing device according to claim 12, wherein the testing device simulates a charging device for the provision of electrical energy for a vehicle that is at least partially electrically driven.

14. The testing device according to claim 13, wherein the second participant of the at least two participants has a control unit for charge management for the vehicle or simulates a control unit for charge management for the vehicle at least in part.

15. The testing device according to claim 1, wherein the testing device tests the communication between a vehicle at least partially electrically powered and a charging device for the provision of electrical energy for the at least partially electrically powered vehicle.

16. A method for testing a communication between at least two participants, the method comprising:
evaluating the communication on the basis of at least one state transition of at least one of the participants, the evaluation comprising a determination of a deviation of the communication from a default, the default comprising information on states and/or state transitions of the at least one participant; and
outputting first data depending on the evaluation.
